(19) United States
(12) Patent Application Publication
(10) Pub. No.: US 2015/0291131 A1
(43) Pub. Date: Oct. 15, 2015

(54) Static Windshield Wiper

(71) Applicant: Edwin Crespo, Juncos, PR (US)

(72) Inventor: Edwin Crespo, Juncos, PR (US)

(21) Appl. No.: 14/107,249

(22) Filed: Dec. 16, 2013

Related U.S. Application Data
(60) Provisional application No. 61/737,794, filed on Dec. 16, 2012.

(51) Int. Cl. B60S 1/04; B60S 1/08

(52) U.S. Cl. CPC B60S 1/0411; B60S 1/08

(57) ABSTRACT

A round convex, concave or flat body, preferably made of glass or any other suitable, usually transparent material solidly secured in a frame that includes mainly an electric motor for rotating the round member and a wiper, like, or resembling those for wiping automobile windshields, windows or any other usually wet surface. When used on motor vehicles, the round part, which is loosely but firmly incased between two grooved glass components; while raining, the powered on motor rotates such round part making it water free; in the process the driver notes that the water disappears without seeing the wiper which remains static by one side and lower front location of the round glass. This assembly can be adapted with its corresponding adapters and fixture to a camera or video recorder to save the user from having to stop his or her operation when the lens get usually wet, thus, obstructing a clear view.

This invention compromises a flat round piece of glass mounted in a frame holding a fixed rubber wiper (3) FIG. 1, resting over a half portion of the glass, (1) FIG. 1, should the glass rotate when it is wet, the liquid gets whipped out, preventing the wiper from being seen.

Especially when it rains, there are many instances that when looking through clear glass a good view is needed or desirable; in the case of motor vehicles, windshield wipers are used to wipe out the drops water. It is evident that the sights of wipers are obstacles for a good view.

This invention is needed and useful to be used on: motor vehicles, cameras, video recorders, airplanes, boats, motorcycles, refrigerated or frozen food showcases (due to the inside and outer haze), etcetera.

A primarily flat, round v convex all around usually clear glass (1) FIG. 1, mounted in a frame (2) FIG. 1, with at least three rotatable supporting members (5) FIG. 1, an electric motor (4) FIG. 1, (10) FIG. 4, with, for example, a metal and rubber pinion (9) FIG. 4, used to rotate the glass by its outward all around side, (8) FIG. 4, such circular glass and it's grove (7) FIG. 3, surrounding windshield parts (2) FIG. 1 along with the pinion (9) FIG. 4 of the motor could be covered with a heavy, durable and flexible layer of material, such as nylon to provide for easy rotation and safety of the components. The parts (2) FIG. 1, for holding the round member is also designed to imprison it securely. A motionless rubber wiper (3) FIG. 1, is positioned over the lower portion of the glass so that when it rains, and the system turned on, the water drops get wiped out due to the turning effect of the revolving glass and the static wiper.

To provide for effective rotation the outer edge of the round member could be especially designed to make it possible to get revolved by an especially designed v shape rubber pulley on the motor (9) FIG. 4, have dents around it or any other effective mean. (FIG. 4)

The moving wipers are said to produce on the driver a hypnotizing consequence, (pendulum effect) especially on long trips, thus, this invention enhances safety.

Another great function of this invention is when recording videos, lacking better means, the operator has to stop her job for cleaning the lenses due to the water, dust or some other foreign material or change the recording to another camera, loosing precious time.

In the case of motor vehicles, to encase the round glass, it is suggested that the front windshield be in two, right and left parts (2) FIG. 1, and the static wiper be secured on one of either two parts with the wiping blade resting on the left or right side of the round part, depending on the rotation direction of the round member.

Heating elements may be provided to completely dry out the revolving glass before its viewing portion reaches the upper area.

### EXPLANATION OF EACH OF THE DRAWINGS

FIG. 1—Shows one of the options: Static Windshield Wiper installed on a motor vehicle.

FIG. 2—Reveals one possible design of the outer edge of the round part of this invention.

FIG. 3—The Static Windshield Wiper encasing assembly not mounted on anything, further indicating the grove through which the round piece slides when rotating.

FIG. 4—Discloses one of the possible mechanisms used to revolve the round glass.

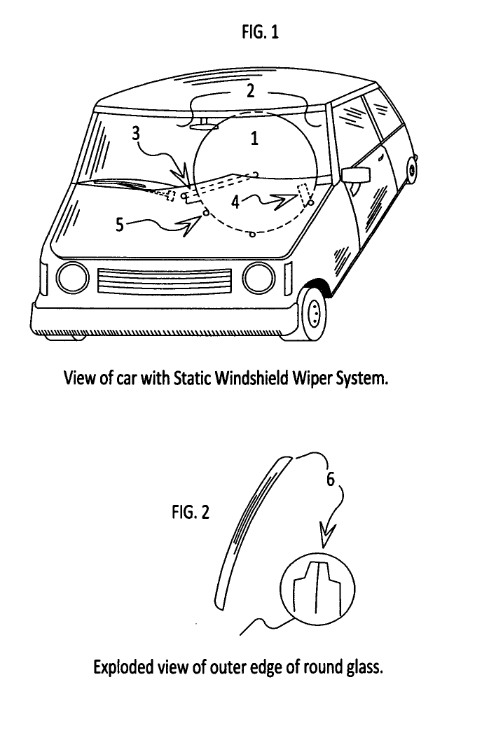

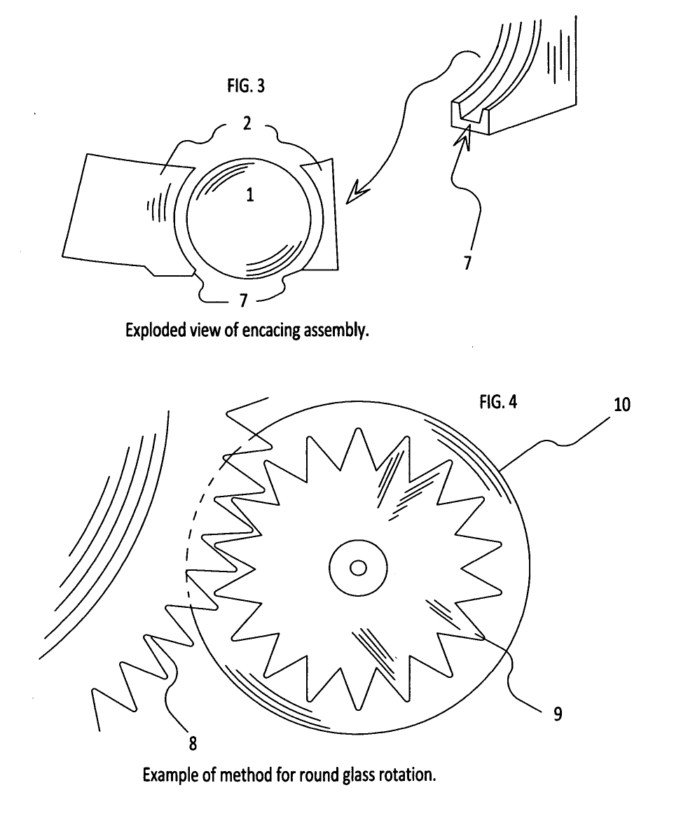

What is claimed is:

1. A round convex, concave or flat body, preferably made of glass or any other suitable, usually see-through material solidly secured in a frame, including, mainly an electric motor for rotating the round member and a wiper, like, or resembling those for wiping motor vehicle's windshields, windows or any other usually wet surfaces. In the situation of gasoline automobiles, the round part, which is loosely but firmly encased between two grooved front windshield components; the operator turns on the motor when it rains so that it rotates the round windshield part, thus, causing the static wiper to remove the water from its surface to have a clear view for safe driving.

2. As in claim 1 but not including the two grooved parts for holding the round member, instead, a channel or the like covering or surrounding in part or completely the round transparent body so that it could be used in different positions, including upside down, for example to be adapted in front of a camera; in this case the whole assembly, including or not the camera itself, should have a cover.
